(19) United States
(12) Patent Application Publication
(10) Pub. No.: US 2004/0015983 A1
(43) Pub. Date: Jan. 22, 2004

(54) Method and apparatus for a data receiver and controller for the facilitation of an enhanced television viewing environment

(76) Inventor: Thomas Lemmons, Evergreen, CO (US)

Correspondence Address: THE LAW OFFICES OF WILLIAM W. COCHRAN, LLC, 3555 STANFORD ROAD, SUITE 230, FORT COLLINS, CO, 80525, US

(21) Appl. No.: 10/422,058

(22) Filed: Apr. 22, 2003

Related U.S. Application Data
(60) Provisional application No. 60/374,898, filed on Apr. 22, 2002.

(51) Int. Cl. H04H 9/00; H04N 7/16

(52) U.S. Cl. 725/12; 725/9

(57) ABSTRACT

Disclosed is a method and system for synchronizing environmental modifiers and actuators with the video and audio components of television programs to produce sensual representations or simulations of suggested environment or actions. The system includes a central device in the viewing household that receives the control data for any and/or all of the environmental modifiers (actuators). This device may be built into the television or associated components or may be entirely independent. The device receives the control signals from any available source and sends the proper control data or signals to the associated peripherals or components.

### CROSS REFERENCE TO RELATED APPLICATIONS

The present application is based upon and claims the benefit of U.S. Provisional Patent Application Serial No. 60/374,898 by Thomas Lemmons, entitled “Method and Apparatus for a Data Receiver and Controller for the Facilitation of an Enhanced Television Viewing Environment” filed Apr. 22, 2002, the entire contents of which is hereby specifically incorporated by reference for all it discloses and teaches.

### BACKGROUND OF THE INVENTION

1. Field of the Invention

The present invention generally pertains to enhanced television and particularly to the method and apparatus for enhancing television-viewing environments.

2. Description of the Background

Despite today's high-tech digital age, television remains a passive medium. Even with the addition of HDTV and surround sound a person remains in a reactive environment. Interactive TV, which is the current technology of letting a person interact with the TV, is not really TV but computer enhancements for television providing for an interface for limited interaction. In order for the TV to take the next step in its evolutionary path, television must go beyond simple interactive computer or game station technology, and engage viewers including non-interactive viewers.

Surround sound equipment and home theater incorporate auditory and spatial orientation into home television theaters. This allows a viewer to get some sense of realism, by associating the auditory input with the environment that is being viewed. However, these systems have been limited to auditory enhancements.

### SUMMARY OF THE INVENTION

The present invention overcomes the disadvantages and limitations of the prior art by providing methods and systems for synchronizing a wide range of environmental modifiers and actuators with the video and audio components of television programs to produce sensual representations or simulations of suggested environments or actions. The system includes a central environmental control system located in the viewing household that receives control data for any and/or all of the environmental modifiers (actuators). This device may be built into the television or associated components or may be entirely independent. The device receives the control signals from any available source, which may be the same source that is sending the television signal, and sends the proper control data or signals to the associated peripherals or components. Th control data can be synchronized with the television signal or can be sent independently with timing identifiers that allow resynchronization to be done on-site. The system may have customization features that allow various users to have a variety of actuating devices. The control device could have the ability to test the system and recognize available devices and redistribute control data or signals to only those devices that exist.

The present invention may therefore comprise a method of enhancing a television-viewing environment by utilizing a set-top box having a central environmental control system to receive an incoming signal containing audio and video signals and codes for a plurality of environmental enhancement devices comprising: extracting the codes for the plurality of environmental enhancement devices from the incoming signal using the central environmental control system, generating a plurality of environmental actuator control signals from the codes for the plurality of environmental enhancement devices using the central environmental control system, independently modifying the plurality of environmental actuator control signals using an actuator intensity level control contained within the central environmental control system that creates a plurality of adjusted environmental actuator control signals, transmitting the plurality of adjusted environmental actuator control signals to the plurality of environmental actuators, modifying the television-viewing environment of the audio and video display location with the plurality of environmental actuators to correspond with a video display.

The present invention may also comprise an apparatus for enhancing a television-viewing environment by utilizing a receiver with a central environmental control system that receives an incoming signal containing audio and video signals and codes for a plurality of environmental enhancement devices comprising: a user preference database disposed in the receiver that stores and provides user preference data, an actuator intensity level control that communicates with the central environmental control system, the central environmental control system independently modifying the environmental actuator control signals to produce adjusted environmental actuator control signals, the central environmental control system comprising: a signal extractor that extracts the codes for the plurality of environmental enhancement devices and generates environmental actuator control signals from the codes, a user preference filter that communicates with the user preference database, that further modifies the adjusted environmental actuator control signals based upon the user preference data, that produces personalized environmental actuator control signals, an actuator output controller that generates customized environmental actuator control signals based upon at least one of the modified environmental actuator control signals, and the personalized environmental actuator control signals, the actuator output controller that transmits the plurality of customized environmental actuator control signals to the plurality of environmental actuators to modify the television-viewing environment to correspond with a video display of the video display device.

The present invention may also comprise a method of automatically inserting environmental indicators in a video stream comprising: analyzing the video stream with a video recognition device to recognize video content and generate video content labels, generating a content ID signal based upon the video content labels, generating segment division markers for the analyzed video stream, comparing the content ID signal to a database of standard environmental content identification tags corresponding to the recognized video content, resynchronizing the assigned environmental tags and markers with the video stream, encoding the delayed video stream with the generated environmental tags and markers data.

The present invention may also comprise a system for automatically inserting environmental indicators in a video stream comprising: a video recognition analyzer that analyzes the video stream to generate environmental content identification tags and segment division markers corresponding to video content of the video stream, standard environmental content identification tags stored in a database, a comparator that compares standard environmental content identification tags with the environmental content identification signals, a time synchronizer that synchronizes the insertion of the assigned environmental content identification tags and the division markers in the video stream, an encoder that encodes the video stream with the environmental content identification tags and the division markers.

Advantages of the present invention are the ability to produce and coordinate a variety of environmental sensations that correspond to the content appearing on a display screen, providing a more realistic sensory experience for the viewer. By adding various environmental modifications that correspond to the passive video event, a greater sense of realism and involvement are experienced by the participant.

Numerous advantages and features of the present invention will become readily apparent from the following detailed description of the invention and the embodiment thereof, from the claims and from the accompanying drawings in which details of the invention are fully and completely disclosed as a part of this specification.

### BRIEF DESCRIPTION OF THE DRAWINGS

In the drawings,

FIG. 1 is a schematic illustration of one embodiment of the overall system of the present invention.

FIG. 2 is a schematic block diagram illustrating one implementation for utilizing a video signal with environmental enhancement codes to control environmental actuators in accordance with the present invention.

FIG. 3 is a schematic illustration of one implementation for an input device for individually controlling the environmental control actuators and entering user preference data.

FIG. 4 is a schematic illustration of one implementation for an input device for individually controlling the environmental control actuators and entering user preference data with a graphical user interface.

FIG. 5 is a schematic block diagram illustrating one implementation for environmental modification from an external video signal.

FIG. 6 is a schematic block diagram illustrating one implementation for automatically inserting environmental control indicators in a delayed video signal.

### DETAILED DESCRIPTION OF THE PREFERRED EMBODIMENT OF THE INVENTION

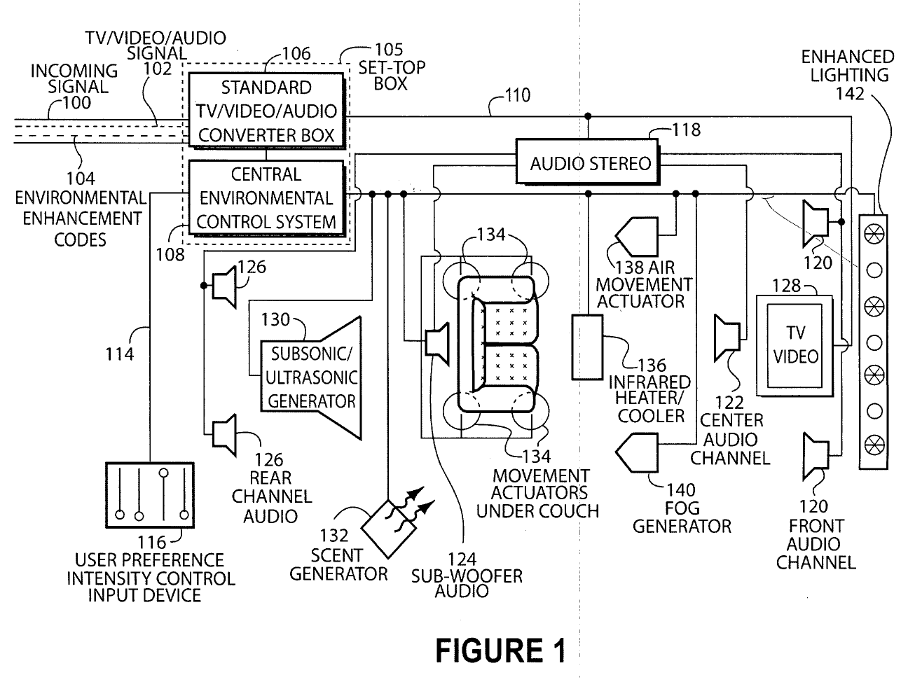

FIG. 1 is a schematic block diagram of one embodiment of the present invention. As shown in FIG. 1, a set-top box 105 receives an incoming signal 100 that contains a TV (video and audio) signal 102 combined with environmental enhancement codes 104. The set-top box 105 contains a standard TV (video and audio) converter box 106 combined with a central environmental control system 108 for managing all the environmental enhancements. The converter box 106 located within the set-top box 105 transmits the standard TV (video and audio) signal 110 directly to the appropriate devices in a conventional manner (TV 128 and stereo audio 118.) The environmental enhancement codes 104 are recognized at the central environmental control system 108 within the set-top box 105. The actuator control signals 112 are decoded for recognition by various environmental controllers delivered to the individual environmental actuators 130-142.

The actuator control signals may be embedded in the VBI of the video signal or in other ways such as disclosed in U.S. Provisional Patent Application Serial No. 60/268,350, filed on Feb. 12, 2001 and U.S. Nonprovisional Patent Application, filed Feb. 12, 2002, both entitled “Video Tags and Markers,” which are specifically incorporated herein by reference for all that they disclose and teach.

Specific functions and intensities of the individual controls can be adjusted with a user preference/intensity control input device 116, which is in electronic communication 114 with the central control system 108 within the set-top box 105. Based upon input from the user preference/intensity control input device 116 and possibly combined with a preprogrammed and real-time user preferences, the central environmental control system 108 delivers specific signals to the individual environmental actuators corresponding to the desired effect that matches the visual situation portrayed on the TV video display 128.

For example, a movie scene with preprogrammed environmental enhancements is received as an incoming signal 100 with the TV (video and audio) portion 102 being converted at 106 into a format recognizable by the TV 128 and stereo 118. The environmental codes 104 for this “ocean lifeboat scene” are processed by the central environmental control system 108 and based upon input from user preference/intensity control input device 116, send out an actuator control signal 112 to each of the environmental actuators. This “ocean lifeboat scene” may include motion in the form of waves experienced by the couch, fog generation, wind, lightning (lighting and subsonic audio,) and ocean smell for instance.

As described in FIG. 1, peripheral environmental modulators (actuators) with centralized control can be integrated to the television or home theater system to create a realistic environment for the user. By using the current data channels provided for interactive or enhanced TV, data could be included with the television signal to control peripherals to provide additional sensory or environmental actions that occur outside of the television. For instance, devices such as scent generators can be used to provide a smell in the viewing environment. These odors could correspond to occurrences of items on the viewing screen such as foods that might be shown in movies, programming or commercials. Non-food objects could likewise be enhanced with the addition of their corresponding odor to the viewing location. For example, a wide variety of odors such as flowers, plants, perfumes, sea mist, cattle drives etc., could be added at the corresponding viewing scenes to give the viewer a greater sense of realism and experience.

Movement generators can be equipped into chairs, couches or other furniture items in the vicinity of the viewing location to simulate motion that would correspond to the visual situation portrayed on the screen. For example, a wave motion could be simulated with the movement generators attached to a chair during ocean scenes. Devices that are able to produce tastes by combining various solutions and depositing it on an inert or edible matrix that is placed in the viewer's mouth can be used in conjunction with the disclosed invention. Baking shows can, for instance, download digitized tastes to viewers by delivering the taste code for that particular food in the enhanced television signal.

Fans, heaters, humidifiers, coolers or other air manipulating devices could also be used to simulate weather or other situational conditions being viewed. Other environmental factors such as lighting, vibration, noise, etc., could be utilized with specific actuators for each of these factors. Subsonic and ultrasonic vibrations could be used to simulate environmental stimuli for the viewer. Air pressure waves could be used for instance to simulate the feel of rain or other tactile sensory effects that would otherwise be logistically impractical.

An advanced environmental controller incorporated within a set-top box may be utilized to process an incoming analog or digital signal that may originate locally as in a video, DVD or other prerecorded storage device, or as a broadcast feed signal such as RF, cable, internet, satellite, etc., or any combination thereof. An individual program would have data embedded into the feed (in the VBI on an analog channel for instance) that consists of control data or scripts for environmental peripherals. The system controller would decode the control signal and distribute this control data to actuate and manage the selected peripherals in a manner that coincides with specific on-screen events.

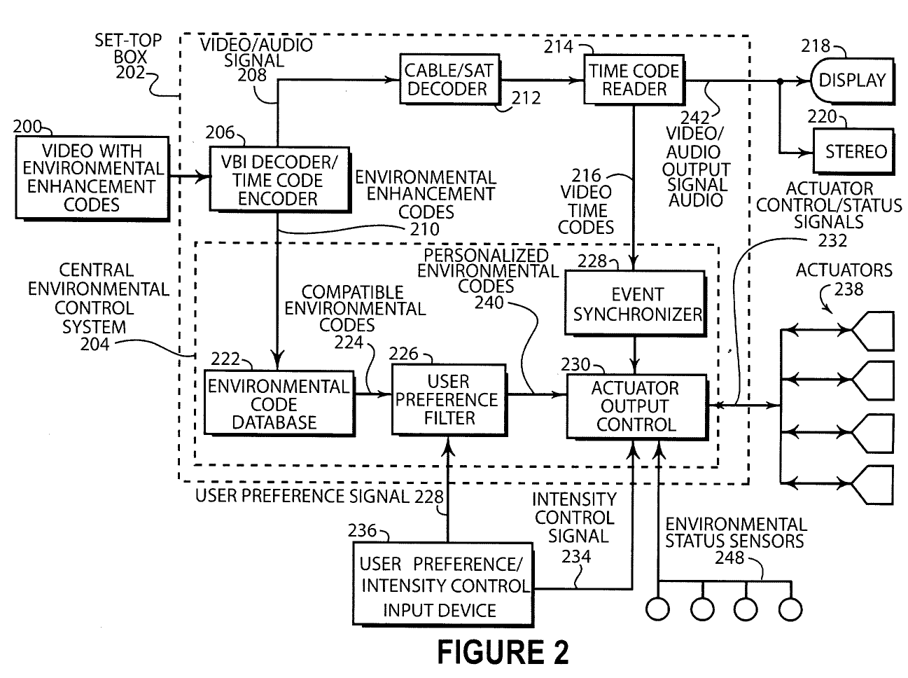

FIG. 2 is a schematic block diagram illustrating one implementation for utilizing a video signal with environmental enhancement codes to control environmental actuators in accordance with the present invention. As shown in FIG. 2, a video signal 200 that has been encoded with environmental enhancement codes in the video blanking interval (VBI) is received by the set-top box 202. A video blanking interval decoder 206 separates the environmental enhancement indicators 210 from the video signal 208 and inserts a time code in the signals for later use in resynchronization of the environmental enhancement signal with the video display signal. The video signal 208 is applied to a cable/satellite decoder 212 in a standard manner. The environmental enhancement indicators 210 are transmitted to the central environmental control system 204 and matched up with known environmental codes contained in an environmental code database 222. Once the indicators 210 are matched with corresponding database codes that the central control system 204 is able to employ, the compatible environmental enhancement codes 224 are subjected to a user preference filter 226 to select particular environmental enhancements that are desired by a particular user at a particular time. A user preference/intensity control input device 236 is used to input user preferences 228 into user preference prefilter 226 and to also input an intensity control signal 234 to the actuator output control 230.

The actuator output control 230 receives the personalized environmental codes 240 from the user preference filter 226, determines the output intensity for the specific actuators from the intensity control signal 234, and synchronizes the actuator output with the video/audio output signal 242. This synchronization is performed by matching time codes encoded by the time code reader 206 of the two signal paths 208 and 210. The event synchronizer 228 receives the video time codes 216 from the time code reader 214, and synchronizes the output of the actuator control/status signals 232 (by the actuator output control) with the video/audio output signal 242. The actuator control/status signals 232 drive the actuators 238 to produce synchronized environmental effects in conjunction with the audio and video output and communicates with the central environmental control system 204 to establish the presence and type of actuators available. The system could also include a feedback mechanism to establish the current status and condition of the viewing environment. This would be done to optimize the performance and regulate the actuation of the peripheral devices in accordance with preprogrammed user limitations and preferences. A plurality of environmental status sensors 248 may communicate with the central environmental control system 204 to give the current status of the viewing environment. For example if a particular environmental condition has perpetuated from a previous actuator stimulation (i.e., cow smell from stampede scene), the feedback mechanism could consider the lingered effect when determining the next actuator stimulation intensity (i.e., horse smell from next stable scene).

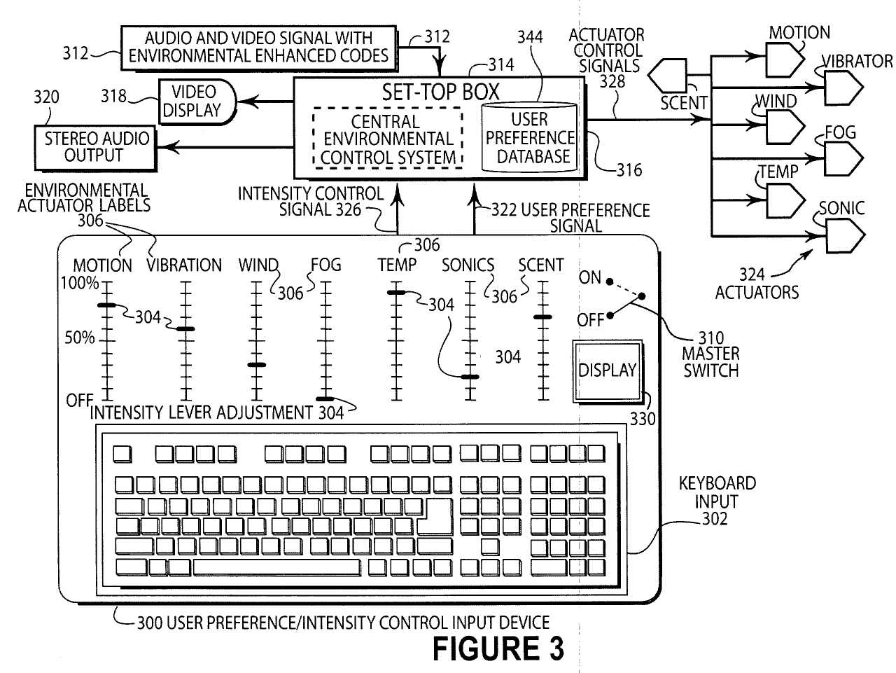

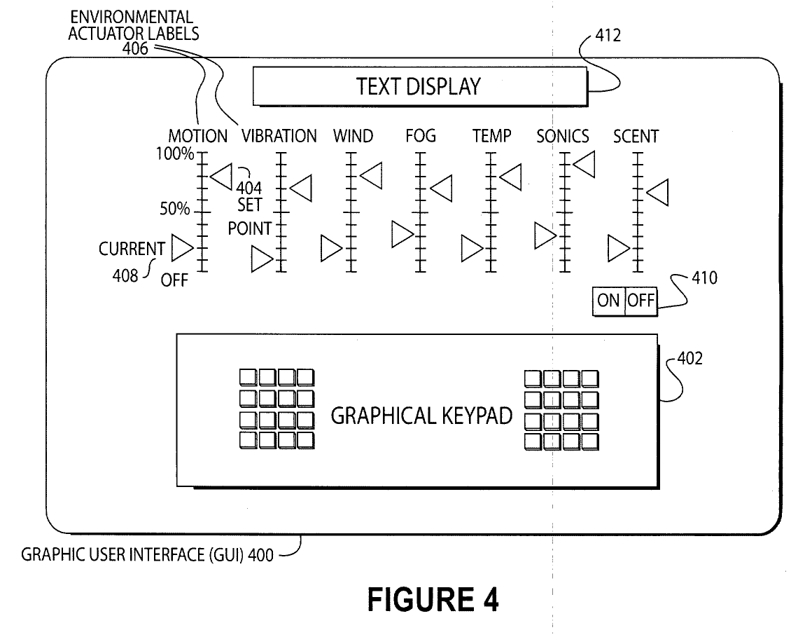

The intensity of any of these environmental enhancements may be also modified by the user preference/intensity control input device 236 that may be within or separate from the central environmental control system 204 to provide individual regulation of each environmental peripheral. This could be performed, for instance, with a series of slider controls that regulate intensity of the specific peripheral from 0-100%. These control devices can separate mechanical controls, as depicted in FIG. 3, or the controls can be represented in a graphical user interface (GUI), as depicted in FIG. 4, and controlled with a microprocessor and displayed on-screen.

FIG. 3 is a schematic illustration of one implementation for an input device for individually controlling the environmental control actuators and entering user preference data. A user preference/intensity control input device 300 supplies user communication and control signals to the central environmental control system 316 within the set-top box 314 via connections 322 and 326. The set-top box 314 receives video signals with environmental codes 312 and utilizes the user preferences 322 and intensity control signals 326 to supply actuator control signals 328 to the actuators 324. The set-top box 314 also processes video and audio signals and distributes them to the video display 318 and the stereo audio output 320. The user preference/intensity control input device 300 is controlled by a master switch 310 and has provision for independently regulating the intensity of individual actuators 324. Individual intensity level adjustments 304 are indicated with environmental actuator labels 306 for easy identification. The intensity can be adjusted from 0% (off) to 100% depending upon what the user prefers. A keyboard 302 is used to supply input for user preferences and profiles that the set-top box 314 can store in a user preference database 344 and use to customize and filter the environmental effects for a particular user or circumstance. Actuator status and text can be displayed on the input device display screen 330.

The user preference/intensity control device can also be implemented with a graphic user interface on the television display screen and can be operated using a remote control device.

For local or broadcast video signals that do not contain enhanced environmental control codes, these codes (i.e., tags and markers) can be generated on-site and inserted in an automated fashion using a database device or in a real-time or near real-time (delayed) fashion in accordance with the present invention. The present invention is capable of providing the tags and markers in a video stream in a simple and easy manner providing a format by which these tags and markers can be used to generate control signals to actuate environmental controls in a variety of different ways. By using audio and video recognition techniques on the incoming signals that do not contain or do not have adequate identifying tags or markers, enabling enhanced environmental controls can be supplied at the end-user site.

The tags and markers can be implemented in XML language to provide a simple and easy manner of generating control signals. Of course, any desired format can be used for implementing the tags and markers. For example, if a video segment contains an ocean scene, the recognition analyzer would match that particular event with a database of standard events and the corresponding programmed response codes can be sent to the central control unit to actuate a proper environmental response. In a similar fashion, audio signals and keywords can be programmed into a database for environmental responses when certain speech or sounds are recognized.

FIG. 4 is a schematic illustration of one implementation for an input device for individually controlling the environmental control actuators and entering user preference data with a graphical user interface. A graphical user interface (GUI) 400 for a user preference/intensity control input device supplies user communication and control signals to the central environmental control system 316 within the set-top box 314 shown in FIG. 3. The GUI 400 works similarly to the electromechanical user preference/intensity control input device 300 of FIG. 3. Actuator control signals are generated from actuator setpoint controls 404 within the GUI that are displayed on a video display device. Current actuator status 408 is also displayed to indicate the current actuator presence and condition. The GUI preference/intensity control input device 400 is controlled by a master switch 410 and has provision for independently regulating the intensity of individual actuators. Individual intensity level adjustments 404 are indicated with environmental actuator labels 406 for easy identification. The intensity can be adjusted from 0% (off) to 100% depending upon what the user prefers. In a similar manner to electromechanical user preference/intensity control input device 300 of FIG. 3, a graphical keypad 402 is used to supply input for user preferences and profiles that the set-top box can store and use to customize and filter the environmental effects for a particular user or circumstance. Actuator status and text can be displayed on a variety of locations such as a text display area 412.

The GUI user preference/intensity control device 400 can also be operated using a remote control device or a hardwired keypad.

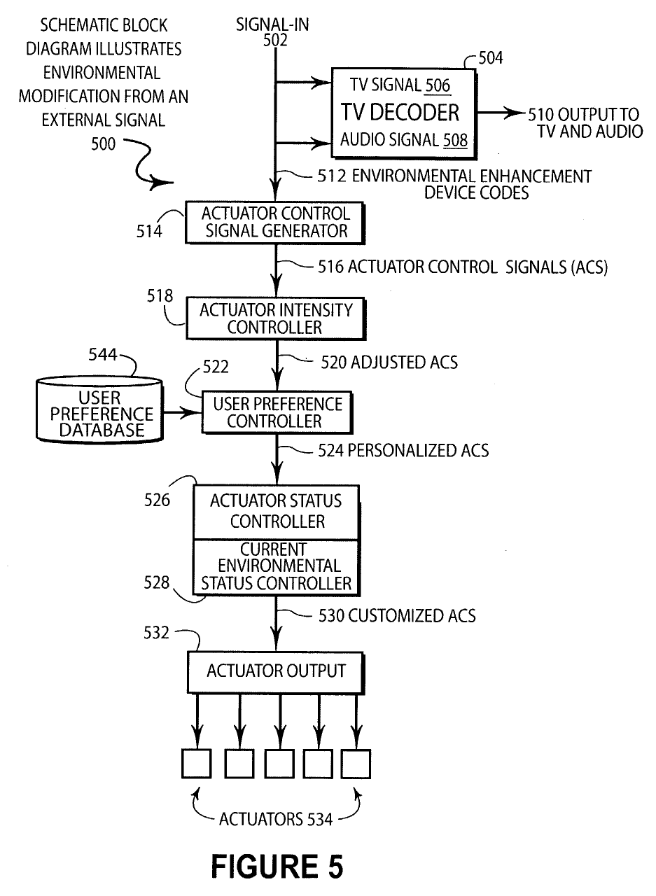

FIG. 5 is a schematic block diagram illustrating one implementation for environmental modification from an external video signal 500. As shown in FIG. 5, an external video signal-in 502 is received by a TV decoder 504 that strips off the video TV signal 506 and the audio signal 508 which are output to TV and audio 510. The environmental enhancement codes 512 present on the signal in 502 are stripped off and input into an actuator control signal generator 514. Actuator control signals (ACS) are output from actuator control signal generator 514 and modified by the actuator intensity controller 518 to provide independent control of the individual actuators as an adjusted ACS 520. The adjusted ACS 520 is compared to a user preference database 544 at the user preference controller 522 to produce a personalized ACS 524. The personalized ACS 524 is input into the actuator status controller 526 and the current environmental status controller 528 to determine the customized ACS output 530 that is transmitted to the actuator output 532 and distributed to a plurality of actuators 534. The actuator status controller 526 and the current environmental status controller 528 serve as a feedback mechanism so that the current environmental and actuator conditions are considered when inputting additional environmental stimulus. For example if a particular environmental condition has perpetuated from a previous actuator stimulation (i.e., cow smell from stampede scene) the feedback mechanism could consider the lingered effect when determining the next actuator stimulation intensity (i.e., horse smell from next stable scene). The intensity of any of these environmental enhancements may be also modified by the user preference database 544 that contains user preferences (i.e., no horse or cow smells).

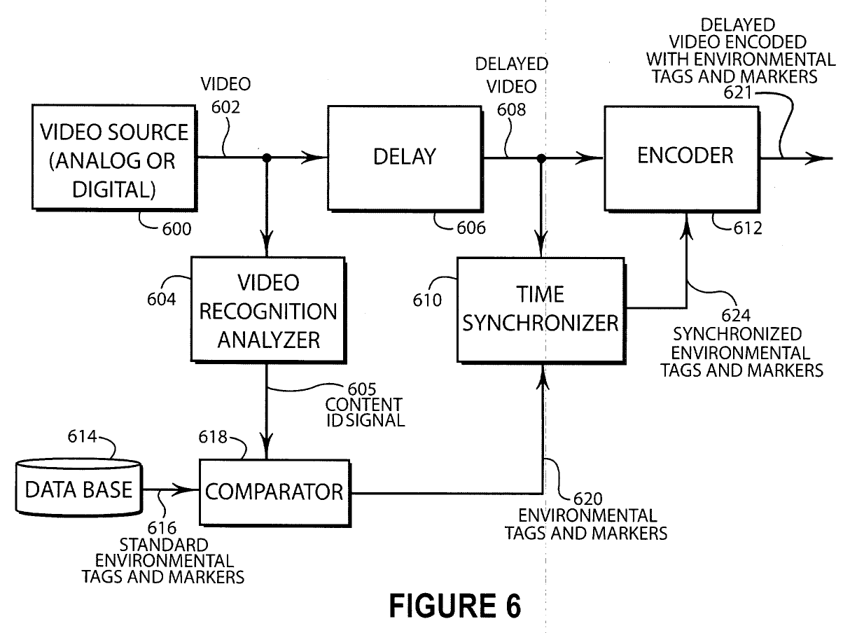

FIG. 6 is a schematic block diagram illustrating the manner in which environmental control tags and markers can be inserted in a delayed video stream automatically, employing an automated input device. As shown in FIG. 6, a video source 600 produces a video signal 602 that is applied to a video recognition analyzer 604 and a delay device 606. A delay device 606 delays the video signal 602 by a predetermined period which may constitute several seconds or several minutes to produce a delayed video signal 608. The delayed video signal is also applied to an encoder 612.

The video recognition analyzer functions to establish content of the video 602 through a variety of techniques such as content codes, graphic recognition, flesh tones, audio keywords, etc. Once the content of the video has been identified, a content ID signal 605 is sent to a comparator 618. The comparator 618 accesses a database 614 to evaluate the content ID signal 605 and assigns the content to standard environmental control tags and markers 616 from the database 614. The environmental control tags and markers 620 are then synchronized with the delayed video 608 with time synchronizer 610. The synchronized environmental control tags and markers 624 are inserted into the delayed video signal 608 by an encoder 612 and output as delayed video encoded with environmental control tags and markers 621.

As described above with regard to FIG. 6, a video recognition analyzer 604 is utilized to identify the content of the video signal 602. The comparator 618 generates tags that may describe the content of the video segment that is being analyzed by the video recognition analyzer 604. This is accomplished by accessing standard tags 616 from the database 614. For example, the tag may indicate the content (weather, ocean, cattle drive, etc.) of a particular video segment or some descriptive keywords that are provided by the database 614 as standard tags. The comparator applies these environmental control tags and markers 620 to the encoder 612 after they are resynchronized with the delayed video 608 by the time synchronizer 610. The delayed video encoded with environmental control tags and markers 621 can then be sent to a set-top box that can utilize the environmental control tags and markers data, or stored on a video storage device, or otherwise used as desired. The above description may also be accomplished on a video signal in a similar manner without splitting the video signal or the delay and resynchronization.

Any type of environmental control signal can be inserted as an indicator in the video stream for any desired purpose in accordance with the spirit of the present invention.

One implementation to describe a tag is a XML file such as provided below:

<Tag>

<ID>3343</ID>
<StartTime>12:45:00</Start Time>
<EndTime>12:46:30</EndTime>
<Actuator>Odor</Actuator>
<OdorCode>1647</OdorCode>
<OdorIntensity>0.58</Odorlntensity>
<OdorDescription>Cattle</OdorDescription>
</Tag>

One implementation to describe a marker is a XML file such as provided below:

<Marker>

<START/>
<ID>3343</ID>
<Alt>Odor</Alt>
</Marker>
<Marker>
<END/>
<ID>3343</ID>
</Marker>

Note that the marker has the same ID as the tag that links these two together.

Another implementation to describe the environmental control tags and markers could be an ASCII text string with defined fields and a check sum such as described below:

[Tag:3343] [StartTime:12.45.00] [EndTime:12.46.30] [Actuator:Odor]
[OdorCode:1647] [Odorlntensity:0.58] [OdorDescription:Cattle
[Marker:Start] [ID:3343]
[CD21]
[Marker:End] [ID:3343] [31AF]

Other implementations to describe the tags and markers could include binary data, bit masking data or any other type data that describes the indicator.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of enhancing a television-viewing environment by utilizing a set-top box having a central environmental control system to receive an incoming signal containing audio and video signals and codes for a plurality of environmental enhancement devices comprising:
extracting said codes for said plurality of environmental enhancement devices from said incoming signal using said central environmental control system;
generating a plurality of environmental actuator control signals from said codes for said plurality of environmental enhancement devices using said central environmental control system;
independently modifying said plurality of environmental actuator control signals using an actuator intensity level control contained within said central environmental control system that creates a plurality of adjusted environmental actuator control signals;
transmitting said plurality of adjusted environmental actuator control signals to said plurality of environmental actuators;
modifying said television-viewing environment of said audio and video display location with said plurality of environmental actuators to correspond with a video display.

2. A method of claim 1 wherein said step of independently modifying said plurality of environmental actuator control signals using said actuator intensity level control contained within said central environmental control system that creates said plurality of adjusted environmental actuator control signals further comprises:
controlling said actuator intensity level with a graphical user interface displayed on said video display.

3. A method of enhancing a television-viewing environment by utilizing a set-top box having a central environmental control system to receive an incoming signal containing audio and video signals and codes for a plurality of environmental enhancement devices comprising:
extracting said codes for said plurality of environmental enhancement devices from said incoming signal using said central environmental control system;
generating a plurality of environmental actuator control signals from said codes for said plurality of environmental enhancement devices using said central environmental control system;
matching said plurality of environmental actuator control signals with user preference data supplied from a user preference database within said set-top box;
further modifying said plurality of adjusted environmental actuator control signals based upon said user preference data to create a plurality of personalized environmental actuator control signals;
transmitting said plurality of personalized environmental actuator control signals to said plurality of environmental actuators;
modifying said television-viewing environment of said audio and video display location with said plurality of environmental actuators to correspond with a video display.

4. A method of enhancing a television-viewing environment by utilizing a set-top box having a central environmental control system to receive an incoming signal containing audio and video signals and codes for a plurality of environmental enhancement devices comprising:
extracting said codes for said plurality of environmental enhancement devices from said incoming signal using said central environmental control system;
generating a plurality of environmental actuator control signals from said codes for said plurality of environmental enhancement devices using said central environmental control system;
sensing presence and characteristics of a plurality of environmental actuators that are connected to said central environmental control system;
sensing current status of said television-viewing environment;
generating a plurality of customized environmental actuator control signals based upon said current status of said television-viewing environment, said plurality of environmental actuator control signals, and said presence and characteristics of said plurality of environmental actuators that are connected to said central environmental control system.
transmitting said plurality of customized environmental actuator control signals to said plurality of environmental actuators;
modifying said television-viewing environment of said audio and video display location with said plurality of environmental actuators to correspond with a video display.

5. A method of enhancing a television-viewing environment by utilizing a set-top box having a central environmental control system to receive an incoming signal containing audio and video signals and codes for a plurality of environmental enhancement devices comprising:
extracting said codes for said plurality of environmental enhancement devices from said incoming signal using said central environmental control system;
generating a plurality of environmental actuator control signals from said codes for said plurality of environmental enhancement devices using said central environmental control system;
independently modifying said plurality of environmental actuator control signals using an actuator intensity level control contained within said central environmental control system that creates a plurality of adjusted environmental actuator control signals;
matching said plurality of adjusted environmental actuator control signals with user preference data supplied from a user preference database within said set-top box;
further modifying said plurality of adjusted environmental actuator control signals based upon said user preference data to create a plurality of personalized environmental actuator control signals;
transmitting said plurality of personalized environmental actuator control signals to said plurality of environmental actuators;
modifying said television-viewing environment of said audio and video display location with said plurality of environmental actuators to correspond with a video display.

6. A method of claim 5 wherein said step of independently modifying said plurality of environmental actuator control signals using said actuator intensity level control contained within said central environmental control system that creates said plurality of adjusted environmental actuator control signals further comprises:
controlling said actuator intensity level with a graphical user interface displayed on said video display.

7. A method of enhancing a television-viewing environment by utilizing a set-top box having a central environmental control system to receive an incoming signal containing audio and video signals and codes for a plurality of environmental enhancement devices comprising:
extracting said codes for said plurality of environmental enhancement devices from said incoming signal using said central environmental control system;
generating a plurality of environmental actuator control signals from said codes for said plurality of environmental enhancement devices using said central environmental control system;
independently modifying said plurality of environmental actuator control signals using an actuator intensity level control contained within said central environmental control system that creates a plurality of adjusted environmental actuator control signals;
sensing presence and characteristics of a plurality of environmental actuators that are connected to said central environmental control system;
sensing current status of said television-viewing environment;
generating a plurality of customized environmental actuator control signals based upon said current status of said television-viewing environment, said plurality of adjusted environmental actuator control signals, and said presence and characteristics of said plurality of environmental actuators that are connected to said central environmental control system.
transmitting said plurality of customized environmental actuator control signals to said plurality of environmental actuators;
modifying said television-viewing environment of said audio and video display location with said plurality of environmental actuators to correspond with a video display.

8. A method of claim 7 wherein said step of independently modifying said plurality of environmental actuator control signals using said actuator intensity level control contained within said central environmental control system that creates said plurality of adjusted environmental actuator control signals further comprises:
controlling said actuator intensity level with a graphical user interface displayed on said video display.

9. A method of enhancing a television-viewing environment by utilizing a set-top box having a central environmental control system to receive an incoming signal containing audio and video signals and codes for a plurality of environmental enhancement devices comprising:
extracting said codes for said plurality of environmental enhancement devices from said incoming signal using said central environmental control system;
generating a plurality of environmental actuator control signals from said codes for said plurality of environmental enhancement devices using said central environmental control system;
matching said plurality of environmental actuator control signals with user preference data supplied from a user preference database within said set-top box;
further modifying said plurality of environmental actuator control signals based upon said user preference data to create a plurality of personalized environmental actuator control signals;
sensing presence and characteristics of a plurality of environmental actuators that are connected to said central environmental control system;
sensing current status of said television-viewing environment;
generating a plurality of customized environmental actuator control signals based upon said current status of said television-viewing environment, said plurality of personalized environmental actuator control signals, and said presence and characteristics of said plurality of environmental actuators that are connected to said central environmental control system.
transmitting said plurality of customized environmental actuator control signals to said plurality of environmental actuators;
modifying said television-viewing environment of said audio and video display location with said plurality of environmental actuators to correspond with a video display.

10. A method of enhancing a television-viewing environment by utilizing a set-top box having a central environmental control system to receive an incoming signal containing audio and video signals and codes for a plurality of environmental enhancement devices comprising:
extracting said codes for said plurality of environmental enhancement devices from said incoming signal using said central environmental control system;
generating a plurality of environmental actuator control signals from said codes for said plurality of environmental enhancement devices using said central environmental control system;
independently modifying said plurality of environmental actuator control signals using an actuator intensity level control contained within said central environmental control system that creates a plurality of adjusted environmental actuator control signals;
matching said plurality of adjusted environmental actuator control signals with user preference data supplied from a user preference database within said set-top box;
further modifying said plurality of adjusted environmental actuator control signals based upon said user preference data to create a plurality of personalized environmental actuator control signals;
sensing presence and characteristics of a plurality of environmental actuators that are connected to said central environmental control system;
sensing current status of said television-viewing environment;
generating a plurality of customized environmental actuator control signals based upon said current status of said television-viewing environment, said plurality of personalized environmental actuator control signals, and said presence and characteristics of said plurality of environmental actuators that are connected to said central environmental control system.
transmitting said plurality of customized environmental actuator control signals to said plurality of environmental actuators;
modifying said television-viewing environment of said audio and video display location with said plurality of environmental actuators to correspond with a video display.

11. A method of claim 10 wherein said step of independently modifying said plurality of environmental actuator control signals using said actuator intensity level control contained within said central environmental control system that creates said plurality of adjusted environmental actuator control signals further comprises:
controlling said actuator intensity level with a graphical user interface displayed on said video display.

12. A method of enhancing a television-viewing environment comprising:
receiving an incoming signal containing audio and video signals and codes for a plurality of environmental enhancement devices using a set-top box, said set-top box containing a television decoder and a central environmental control system;
extracting said video signal from said incoming signal using said television decoder;
transmitting said video signal to a video display device using said television decoder;
extracting said audio signal from said incoming signal using said television decoder;
transmitting said audio signal to an audio output device using said television decoder;
extracting said codes for said plurality of environmental enhancement devices from said incoming signal using said central environmental control system;
generating a plurality of environmental actuator control signals from said codes for said plurality of environmental enhancement devices using said central environmental control system;
independently modifying said plurality of environmental actuator control signals using an actuator intensity level control contained within said central environmental control system that creates a plurality of adjusted environmental actuator control signals;
matching said plurality of adjusted environmental actuator control signals with user preference data supplied from a user preference database within said set-top box;
further modifying said plurality of adjusted environmental actuator control signals based upon said user preference data to create a plurality of personalized environmental actuator control signals;
sensing presence and characteristics of a plurality of environmental actuators that are connected to said central environmental control system;
sensing current status of said television-viewing environment;
generating a plurality of customized environmental actuator control signals based upon said current status of said television-viewing environment, said plurality of personalized environmental actuator control signals, and said presence and characteristics of said plurality of environmental actuators that are connected to said central environmental control system.
transmitting said plurality of customized environmental actuator control signals to said plurality of environmental actuators;
modifying said television-viewing environment of said audio and video display location with said plurality of environmental actuators to correspond with a video display.

13. A method of claim 12 wherein said step of independently modifying said plurality of environmental actuator control signals using said actuator intensity level control contained within said central environmental control system that creates said plurality of adjusted environmental actuator control signals further comprises:
controlling said actuator intensity level with a graphical user interface displayed on said video display.

14. An apparatus for enhancing a television-viewing environment by utilizing a receiver with a central environmental control system that receives an incoming signal containing audio and video signals and codes for a plurality of environmental enhancement devices comprising:
a user preference database disposed in said receiver that stores and provides user preference data;
an actuator intensity level control that communicates with said central environmental control system, said central environmental control system independently modifying said environmental actuator control signals that produce adjusted environmental actuator control signals;
said central environmental control system comprising:
a signal extractor that extracts said codes and generates environmental actuator control signals from said codes;
a user preference filter that communicates with said user preference database, that further modifies said adjusted environmental actuator control signals based upon said user preference data, that produces personalized environmental actuator control signals;
an actuator output controller that generates customized environmental actuator control signals based upon at least one of said modified environmental actuator control signals, and said personalized environmental actuator control signals;
said actuator output controller that transmits said plurality of customized environmental actuator control signals to said plurality of environmental actuators to modify said television-viewing environment to correspond with a video display of said video display device.

15. The apparatus of claim 14 wherein said actuator intensity level control is an electro-mechanical interface.

16. The apparatus of claim 14 wherein said actuator intensity level control is a graphical user interface displayed on said video display.

17. An apparatus for enhancing a television-viewing environment by utilizing a receiver with a central environmental control system that receives an incoming signal containing audio and video signals and codes for a plurality of environmental enhancement devices comprising:
a user preference database disposed in said receiver that stores and provides user preference data;
a plurality of environmental status sensors that communicate with said central environmental control system and provide a current status of said television-viewing environment;
said central environmental control system comprising:
a signal extractor that extracts said codes for said plurality of environmental enhancement devices and generates environmental actuator control signals from said codes;
a detector that detects the presence and characteristics of said plurality of environmental actuators that are connected to said central environmental control system;
an actuator output controller that generates customized environmental actuator control signals based upon at least one of said current status of said television-viewing environment, said presence and characteristics of said plurality of environmental actuators, and said environmental actuator control signals;
said actuator output controller that transmits said plurality of customized environmental actuator control signals to said plurality of environmental actuators to modify said television-viewing environment to correspond with a video display of said video display device.

18. An apparatus for enhancing a television-viewing environment by utilizing a receiver with a central environmental control system that receives an incoming signal containing audio and video signals and codes for a plurality of environmental enhancement devices comprising:
a user preference database disposed in said receiver that stores and provides user preference data;
an actuator intensity level control that communicates with said central environmental control system, said central environmental control system independently modifying said environmental actuator control signals that produce adjusted environmental actuator control signals;
a plurality of environmental status sensors that communicate with said central environmental control system and provide a current status of said television-viewing environment;
said central environmental control system comprising:
a signal extractor that extracts said codes for said plurality of environmental enhancement devices and generates environmental actuator control signals from said codes;
a detector that detects the presence and characteristics of said plurality of environmental actuators that are connected to said central environmental control system;
a user preference filter that communicates with said user preference database that further modifies said adjusted environmental actuator control signals based upon said user preference data that produces personalized environmental actuator control signals;
an actuator output controller that generates customized environmental actuator control signals based upon at least one of said current status of said television-viewing environment, said presence and characteristics of said plurality of environmental actuators, said modified environmental actuator control signals, and said personalized environmental actuator control signals;
said actuator output controller that transmits said plurality of customized environmental actuator control signals to said plurality of environmental actuators to modify said television-viewing environment to correspond with a video display of said video display device.

19. The apparatus of claim 14 wherein said actuator intensity level control is an electro-mechanical interface.

20. The apparatus of claim 14 wherein said actuator intensity level control is a graphical user interface displayed on said video display.

21. An apparatus for enhancing a television-viewing environment comprising:
a receiver that receives an incoming signal containing video and audio signals and codes for a plurality of environmental enhancement devices, said receiver including a central environmental control system;
a video display device connected to said television decoder, said video display device that receives decoded video signals transmitted from said receiver;
an audio output device connected to said television decoder, said audio output device that receives decoded audio signals transmitted from said receiver, a user preference database disposed in said receiver that stores and provides user preference data;
an actuator intensity level control that communicates with said central environmental control system, said central environmental control system independently modifying said environmental actuator control signals that produce adjusted environmental actuator control signals;
a plurality of environmental status sensors that communicate with said central environmental control system and provide a current status of said television-viewing environment;
said central environmental control system comprising:
a signal extractor that extracts said codes for said plurality of environmental enhancement devices and generates environmental actuator control signals from said codes;
a detector that detects the presence and characteristics of said plurality of environmental actuators that are connected to said central environmental control system;
a user preference filter that communicates with said user preference database that further modifies said adjusted environmental actuator control signals based upon said user preference data that produces personalized environmental actuator control signals;
an actuator output controller that generates customized environmental actuator control signals based upon at least one of said current status of said television-viewing environment, said presence and characteristics of said plurality of environmental actuators, said modified environmental actuator control signals, and said personalized environmental actuator control signals;
said actuator output controller that transmits said plurality of customized 35 environmental actuator control signals to said plurality of environmental actuators to modify said television-viewing environment to correspond with a video display of said video display device.

22. The apparatus of claim 21 wherein said actuator intensity level control is an electro-mechanical interface.

23. The apparatus of claim 21 wherein said actuator intensity level control is a graphical user interface displayed on said video display.

24. A method of automatically inserting environmental indicators in a video stream comprising:
analyzing said video stream with a video recognition device to recognize video content and generate video content labels;
generating a content ID signal based upon said video content labels;
generating segment division markers for said analyzed video stream;
comparing said content ID signal to a database of standard environmental content identification tags corresponding to said recognized video content;
resynchronizing said assigned environmental tags and markers with said video stream;
encoding said delayed video stream with said generated environmental tags and markers data.

25. A system for automatically inserting environmental indicators in a video stream comprising:
a video recognition analyzer that analyzes said video stream to generate environmental content identification tags and segment division markers corresponding to video content of said video stream;
standard environmental content identification tags stored in a database;
a comparator that compares standard environmental content identification tags with said environmental content identification signals;
a time synchronizer that synchronizes the insertion of said assigned environmental content identification tags and said division markers in said video stream;
an encoder that encodes said video stream with said environmental content identification tags and said division markers.
